(19) United States
(12) Patent Application Publication
(10) Pub. No.: US 2017/0364616 A1
(43) Pub. Date: Dec. 21, 2017

(54) METHODS AND SYSTEMS FOR INVESTIGATION AND PREDICTION OF SLUG FLOW IN A PIPELINE

(71) Applicant: SCHLUMBERGER TECHNOLOGY CORPORATION, Sugar Land, TX (US)

(72) Inventors: Alexander Lukyanov, Cambridge, MA (US); Boris Krasnopolsky, Moscow (RU); Alexander Starostin, Abingdon (UK); Natalia Lebedeva, Moscow (RU)

(21) Appl. No.: 15/624,995

(22) Filed: Jun. 16, 2017

Related U.S. Application Data
(60) Provisional application No. 62/351,544, filed on Jun. 17, 2016.

(51) Int. Cl. G06F 17/50; G06F 17/13

(52) U.S. Cl. CPC G06F 17/5009; G06F 17/13

(57) ABSTRACT

Methods and apparatus for investigating and predicting slug flow in complex pipes are disclosed. More particularly, the techniques provide a model of multiphase flow in a complex pipeline and its solution acquired using the Jacobian-Free Newton-Krylov (JFNK) method by way of non-limiting example. The fully implicit formulation framework described in this work enables to efficiently solve governing fluid flow equations. The framework can reduce the multiphase flow model in zones or cells of the pipe that exhibit phase disappearance based on the phase state distributions over the cells. The model of multiphase flow can include a model for single-phase cells that is different from a model for multiphase cells, and the proper model can be selected (or switched) as the phase characteristics of the multiphase flow of the cells change over time. A transient two-fluid model can be used to verify and validate the proposed algorithm for conditions of terrain-induced slug flow regime. The model can identify all the major features of experimental data, and is in a good quantitative agreement.

### CROSS-REFERENCE TO RELATED APPLICATION(S)

This application claims priority from U.S. Provisional Patent Appl. No. 62/351,544, filed on Jun. 17, 2016, herein incorporated by reference in its entirety.

### BACKGROUND

### 1. Field

The present disclosure relates to methods and apparatus that investigate and/or predict slug flow in a pipeline.

### 2. State of the Art

Petroleum composition data plays a role in guiding both upstream and downstream operations, including: predicting fluid behavior inside a petroleum reservoir, providing flow assurance during transportation of the petroleum, understanding potential outcomes when mixing or blending or diluting the petroleum, and directing refinement processes.

The term “slug” or “slugs” or “slug flow” as used herein refers to a multiphase (gas-liquid) flow regime in a flow channel. For example, a lighter gas phase can be contained in large bubbles that are dispersed within, and push along, a heavier liquid phase. In such an example, the heavier liquid phase may be continuous along the wall(s) of the flow channel. While the slug may often refer to the heavier liquid phase, it may also sometimes refer to the bubbles of the lighter gas phase. There may also be smaller gas phase bubbles within the liquid phase, but many of these have coalesced to form the large gas phase bubbles until they span much of the flow channel.

Slug flow is a factor in flow assurance in hilly terrain pipelines associated with highly transient rates of multiple phases, which may present operational problems for downstream petroleum receiving facilities. Design and development of systems that investigate and predict slug flow in such pipelines need efficient numerical simulations of multiphase flows with precise and fast prediction of the occurrence of slug flow with resolution in complex pipeline geometries. Some industrial simulators of multiphase pipe flows include OLGA Dynamic Multiphase Flow Simulator from Schlumberger Limited and LedaFlow® from LEDAFLOW Technologies DA of Norway.

Prior art approaches for modelling slug flows are based on different types of multiphase models, e.g. steady-state model, transient drift-flux model, and transient multi-fluid model. U.S. Patent Application Publication No. 2013/0317791 relates to an averaged approach for slug flow modelling based on stable solutions to the multiphase flow, which coexist at different points in a pipeline. Also, U.S. Pat. No. 5,550,761 relates to a method based on a drift-flux model that can roughly describe intermittent slug flow as a combination of separated flow patterns (stratified or annular) and dispersed flow patterns.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Reliable modeling of multiphase pipe flows employs fast and robust numerical techniques suitable for one-dimensional (1D) transient multi-fluid flow simulations. Preferably, the modelling approach can model a plurality of inclination angles, a plurality of flow regimes, and flow regime transitions. According to one aspect, further details of which are described herein, methods are provided for investigating and predicting slug flow in a pipe based on computationally-efficient numerical techniques. In particular, the present disclosure provides a consistent and robust numerical formulation for a mathematical model of slug flow in an inclined pipe, as well as the methodology for slug investigation and prediction of slug flow based on numerical solutions, together with control and management of slug flow when it is predicted to occur.

In accordance with one embodiment, a method is provided for investigating and predicting slug flow in inclined pipes. The method is conceptually different from the prior art approaches in that the methods described herein allow for identifying the slug flow regimes through mass conservative, fully implicit solutions of the underlying single- and multi-phase governing equations using a switching algorithm within the fully implicit framework described herein.

The methods for investigating and predicting slug flow may include numerical modelling of multiphase flows. Also, methods of managing and controlling slug flow may be based on the results of the numerical modelling. The methods may be based on one-dimensional, transient, multi-fluid model and numerical methods that identify slug flow in inclined pipes. In contrast to the empirical approaches described in the prior art, one feature of the methods described herein is the capability of directly predicting the evolution from stratified flow to slug flow, as well as slug transfer, without using any additional empirical criteria or closures.

In that regard, the methods described herein expressly address modelling the transition to slug flow when a fluid phase disappears in a segment of the pipe, i.e., when a gas phase disappears from a mixture of gas and liquid. Specifically, the methods described herein for modelling slug flow in a pipe can be based on a phase state distribution over cells defined in a pipe grid and on switching between sets of equations for each cell based on the phase state. To implement the methods described herein, the Jacobian-Free Newton-Krylov (JFNK) method may be used, by way of non-limiting example.

In one embodiment, a method of identifying slug flow in a pipeline having at least one inclined pipe segment (including positive, negative, and zero inclination) is provided. The method includes logically partitioning the pipeline into segments. At least one segment is angled at an angle of inclination with respect to horizontal (including positive, negative, and zero inclination angles for all segments). A plurality of one-dimensional cells is defined along the length of each segment of the pipeline. Physical parameters (such as pressure) are measured for each segment of the pipeline over time. Such physical parameters are used to model the multiphase flow in the cells of each segment of the pipeline over time. The model of the multiphase flow can include phase state distributions for each cell. The phase state distributions of the cells of a respective pipeline segment over time can be evaluated to investigate and predict the occurrence of slug flow in the respective pipeline segment. When it is determined that slug flow is predicted to occur, various control and management schemes can be automatically employed in order to alleviate or minimize such slug flow.

The phase state distributions of the cells may indicate whether the cell has a single phase or is a multiphase cell. Also, the phase state distribution of the cells may represent volume fraction distributions for the different phases (e.g., liquid and gas) of the multiphase flow in the cells. The method may also include analyzing the phase state distributions of the cells to identify slug flow behavior in a time period of interest.

The model of multiphase flow can include a model for single-phase cells that is different from a model for multiphase cells, and the proper model can be selected (or switched) as the phase characteristics of the multiphase flow of the cells change over time.

The model of multiphase can be generated using a discrete form of a system of partial differential equations that model, based on the plurality of aforementioned measurements, the multiphase flow in the cells of each segment of the pipeline over time. The system of partial differential equations can be iteratively solved to characterize the multiphase flow in the cells of each segment of the pipeline over a time period of interest. The solution to the system of equations for the time period of interest can be evaluated to identify slug flow behavior in a time period of interest. Each iteration may include approximating a rough solution to the system of partial differential equations, and iteratively solving the system of partial differential equations for a respective time step in the time period of interest based on an identified phase state distribution amongst the cells based on a volume fractions distribution amongst the cells.

### BRIEF DESCRIPTION OF THE DRAWINGS

The accompanying drawings, which are incorporated in and constitute a part of this specification, illustrate embodiments of the present teachings and together with the description, serve to explain the principles of the present application.

FIG. 1 illustrates an example of a portion of pipe of an arbitrary inclination partial.

FIG. 2 illustrates an example of the tree-like graph of the mixture.

FIG. 3 schematically illustrates a simulation grid.

FIG. 4 illustrates W-shaped pipe set up.

FIG. 5 illustrates Outlet flow rates for flow in W-shaped pipe.

FIG. 6 illustrates Pressure in the first elbow of the W-shaped pipe.

FIG. 7 illustrates a schematic view of the simulation process 700.

FIG. 8 illustrates a schematic view of a computing or processor system 800, according to an embodiment.

### DETAILED DESCRIPTION

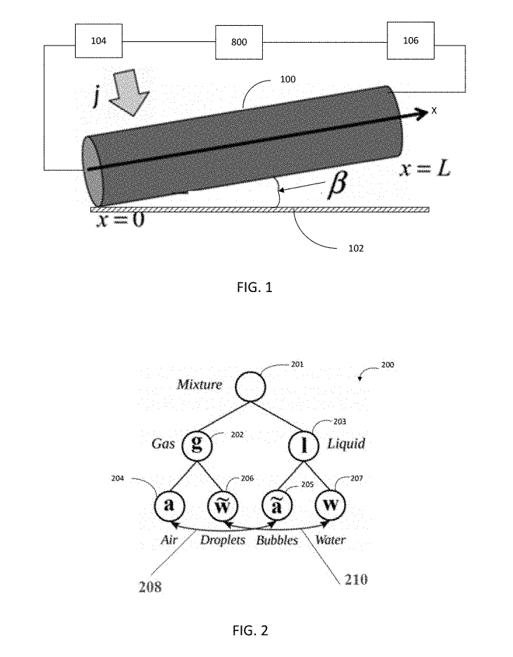

FIG. 1 illustrates schematically a section of pipe 100 of a pipeline that is inclined at a positive angle β with respect to horizontal 102. The pipe 100 has a length “L” and the pipe extends along an axis “x” from a first end or inlet where the axial position is x=0 to a second end or outlet where the axial position is x=L. The arrow represents an influx “j” of fluid into the pipe 100. While only one section of pipe is shown in FIG. 1, it will be appreciated that other sections of pipe may be coupled to pipe 100 to form the pipeline at the same or different angle β (including zero or negative angles), and measurements of each section of pipe may be made in the same way as described herein for pipe 100. As will be discussed in detail below, to model the flow through the pipe 100, the inner volume of the pipe 100 may be conceptually divided into a series of one-dimensional flow cells along the axial “x” direction.

A pressure P1 at the inlet of the pipe section 100 may be measured using a pressure sensor 104 and a pressure P2 at the outlet of the pipe section 100 may be measured using a pressure sensor 106. Pressure Sensors 104 and 106 may be communicatively coupled to a processing system 800, described in greater detail below. It will be appreciated that the fluid properties at the interfaces of the boundaries between adjacent real and ghost cells over time will be the same to maintain consistency. Thus, the pressure P1 at the inlet of the pipe section 100 may serve as the pressure of a cell located at the outlet of the pipe section upstream of the pipe section 100, while the pressure P2 at the outlet of the pipe section 100 may serve as the pressure to a cell located at the inlet of a pipe section downstream of the pipe section 100. Thus, the pressures P1 and P2 may serve as boundary conditions for the model described herein.

The following discussion relates to modeling parameters of fluid flowing in the pipe 100 and assumes a transient isothermal multiphase flow of a mixture (mixture flow) in the pipe 100. The mixture is modeled as containing several immiscible, compressible or incompressible phases (fluids or phases). For example, the mixture includes N_{f} fluids containing N_{c} continuous components and N_{\tilde{c}} dispersed components which are described within the multi-fluid formulation. A set of components (continuous k and dispersed \tilde{k}) is denoted I_{γ}={k, \tilde{k}}, which forms γ fluid phase. By way of non-limiting example shown in FIG. 2, a mixture of gas and liquid is considered below for simplicity of algorithm description.

Each phase may have continuous or dispersed components, e.g., gas layer (continuous) or bubbles (dispersed), liquid layer (continuous) or droplets (dispersed). Gas-liquid pipe flow may be described with the multiphase model with continuous gas and liquid phases with additional dispersed phases of gas bubbles and liquid droplets. For example, FIG. 2 shows a tree diagram 200 of an example mixture with a single root with a first set of branches denoting phases (gas 202 and liquid 203) of the mixture 201 and a second set of branches denoting components 204, 206, 205, and 207 of the phases (continuous and dispersed). In FIG. 2, gas is denoted “g”, liquid is denoted “l”, and “a” 204 denotes the continuous component (air) of the gas phase 202, “\tilde{w}” 206 denotes the dispersed component (droplet) of the gas phase 202, “ã” 205 denotes the dispersed component (bubble) of the liquid phase 203, and “w” 207 is the continuous component (water) of the liquid phase 203. As shown by the arrows 208 and 210, the dispersed and continuous components may switch phases over time when the mixture 201 flows through the pipe 100. Modeling this behavior is one of the features described hereinbelow.

To model the flow through the pipe 100 the inner volume of the pipe may be conceptually divided into flow cells along the axial “x” direction. The governing equations describing flow of the above-described mixture 201 are based on one-dimensional (i.e., flow in the axial “x” direction in FIG. 1) transient mass and momentum conservation equations for fluids and components and formulated as follows:

$$\begin{matrix} \frac{\partial ( {α}_{k} {ρ}_{k} A )}{\partial t} + \frac{\partial ( {α}_{k} {ρ}_{k} {u}_{k} A )}{\partial x} = {J}_{k} , k = a , w & ( 1 ) \\ \frac{\partial ( {α}_{\tilde{k}} {ρ}_{\tilde{k}} A )}{\partial t} + \frac{\partial ( {a}_{\tilde{k}} {ρ}_{\tilde{k}} {u}_{\tilde{k}} A )}{\partial x} = {J}_{\tilde{k}} , \tilde{k} = \tilde{a} , \tilde{w} & ( 2 ) \\ \frac{\partial ( {\tilde{α}}_{γ} {\tilde{ρ}}_{γ} {\tilde{u}}_{γ} A )}{\partial t} + \frac{\partial ( {\tilde{α}}_{γ} {\tilde{ρ}}_{γ} {\tilde{u}}_{γ}^{2} A )}{\partial x} = - A {\tilde{α}}_{γ} \frac{\partial p}{\partial x} - {\tilde{α}}_{γ} {\tilde{ρ}}_{γ} ( g sin β + g cos β \frac{\partial h}{\partial x} + {P}_{I} \frac{\partial {\tilde{α}}_{γ}}{\partial x} ) - {Φ}_{γ} , y = g , l & ( 3 ) \\ {ρ}_{\tilde{a}} = {ρ}_{\tilde{a}} ( p ) & ( 4 ) \\ {ρ}_{\tilde{w}} = {ρ}_{\tilde{w}} ( p ) & ( 5 )\end{matrix}$$

In the foregoing equations (1) to (5), αₖ, α_{\acute{k}}, \tilde{α}_{γ} are volume fractions; J_{\tilde{k}}, J_{\tilde{k}} are mass inflow, ρₖ, ρ_{\tilde{k}} are densities, Φ_{γ} is the friction term, uₖ, u_{\tilde{k}}, ũ_{γ} are the velocity and, p is the pressure, g is the gravity acceleration, β is the inclination angle of a pipe and the angle may be positive (inclined up), negative (inclined down), or zero (if horizontal),

$$A = \frac{π {D}^{2}}{4}$$

is the pipe cross section (the constant pipe section of area A is used for numerical simulations by way of non-limiting example), D is the internal pipe diameter, h is a liquid level of the segregated flow, P₁ is an interfacial pressure, t is the time, and x is a longitudinal coordinate along the length of the pipe (e.g., distance from an end of the pipe). To close the system of equations, the following expressions for volume fractions and densities are added, as well as expression for no-slip relative motion between continuous and dispersed phases:

\tilde{α}_{g}=αₐ+α_{\acute{w}},\acute{α}ₗ=α_{ã}+α_{w},\tilde{α}₁+\acute{α}_{g}=1 (6)

\tilde{α}_{g}\tilde{ρ}_{g}=αₐρₐ+α_{\tilde{w}}ρ_{\tilde{w}},\tilde{α}ₗ\tilde{ρ}ₗ=α_{\tilde{α}}ρ_{ã}+α_{w}ρ_{w} (7)

For simplicity, by way of non-limiting example, it is assumed that there is no relative motion between components and its carrying fluid (or phase). Thus, the following relationship is also used.

uₗ=u_{ã}=u_{\tilde{w}},u_{g}=uₐ=u_{\tilde{w}} (8)

Also, by way of non-limiting example, it is assumed that corresponding continuous and dispersed components (e.g., air “a” 204 and bubbles “ã” 205) have the same density. Thus, as per one-to-one mapping P:kεI_{γ} [symbol] \tilde{k}εI_{ω},γ≠ω of components presented in the tree-like diagram of FIG. 2:

ρₖ=ρ_{\tilde{k}},\tilde{k}=P(k),k=1, . . . ,N_{c} (9)

Thus, in the example of FIG. 2, ρₐ=ρ_{ã} and ρ_{w}=ρ_{\tilde{w}}.

Also, to close the system of equations, equations of state ρₖ=ρₖ(p) are defined, as well as expressions for P₁ and Φₖ. The terms P₁ and Φₖ depend on the flow regime and may be defined based on experimental data as algebraic functions of the flow parameters defined by user input. In general, the model defined by equations (1) to (9) includes 3N_{c}+N_{f}+1 primary unknowns and equations and, in particular, 9 unknown variables and equations for the considered case where N_{c}=2, N_{f}=2.

In the numerical simulation, a formulation plays an important role. This normally refers to the equations (1) to (9), closures, and specification of primary variables. In the example of the mixture 201 of FIG. 2, this leads to the representation of governing equations as:

w=(pαₐα_{w}α_{ã}α_{\tilde{w}}ρₐρ_{w}ũ_{g}\tilde{μ}_{w})^{T}

R̅(w)=0. (10)

This formulation also includes equations and variables line-up, and the numerical methods (i.e., implicit and/or explicit discretization schemes of different orders) and techniques used to solve the set of nonlinear and linear equations. A fully implicit formulation for all variables is used leading to the following residuals for the mixture 201 described by FIG. 2, by way of non-limiting example:

$$R ( w ) = ( \begin{matrix}{\tilde{α}}_{g} + {\tilde{α}}_{l} - 1 \\ \frac{\partial ( {α}_{a} {ρ}_{a} A )}{\partial t} + \frac{\partial ( {α}_{a} {ρ}_{a} {Au}_{a} )}{\partial x} - {J}_{a} \\ \frac{\partial ( {α}_{\tilde{w}} {ρ}_{w} A )}{\partial t} + \frac{\partial ( {α}_{\tilde{w}} {ρ}_{w} {Au}_{\tilde{w}} )}{\partial x} - {J}_{\tilde{w}} \\ \frac{\partial ( {α}_{\tilde{a}} {ρ}_{a} A )}{\partial t} + \frac{\partial ( {α}_{\tilde{a}} {ρ}_{a} {Au}_{\tilde{a}} )}{\partial x} - {J}_{\tilde{a}} \\ \frac{\partial ( {α}_{w} {ρ}_{w} A )}{\partial t} + \frac{\partial ( {α}_{w} {ρ}_{w} {Au}_{w} )}{\partial x} - {J}_{w} \\ {ρ}_{a} - {ρ}_{a} ( p ) \\ {ρ}_{w} - {ρ}_{w} ( p ) \\ \frac{\partial ( {\tilde{α}}_{l} {\tilde{ρ}}_{l} A {\tilde{u}}_{l} )}{\partial t} + \frac{\partial ( {\tilde{α}}_{l} {\tilde{ρ}}_{l} A {\tilde{u}}_{l}^{2} )}{\partial x} + {\tilde{α}}_{l} A \frac{\partial p}{\partial x} + {\tilde{α}}_{l} {\tilde{ρ}}_{l} ( g sin β + g cos β \frac{\partial h}{\partial x} + {P}_{I} \frac{\partial {\tilde{α}}_{l}}{\partial x} ) + {Φ}_{l} \\ \frac{\partial ( {\tilde{α}}_{g} {\tilde{ρ}}_{g} A {\tilde{u}}_{g} )}{\partial t} + \frac{\partial ( {\tilde{α}}_{g} {\tilde{ρ}}_{g} A {\tilde{u}}_{g}^{2} )}{\partial x} + {\tilde{α}}_{g} A \frac{\partial p}{\partial x} + {\tilde{α}}_{g} {\tilde{ρ}}_{g} ( g sin β + g cos β \frac{\partial h}{\partial x} + {P}_{I} \frac{\partial {\tilde{α}}_{g}}{\partial x} ) + {Φ}_{g}\end{matrix} ) \qquad ( 11 )$$

The different types of boundary conditions may be used with the formulation. For example, a “velocity” boundary condition, can be used for cells at both ends of the pipe 100. The velocity boundary condition assumes specified velocities of the fluids as a function of time. Alternatively, “pressure” boundary condition, can be used for cells at both ends of the pipe, as discussed above with reference to pipe 100 of FIG. 1. The pressure boundary condition assumes specified pressure as a function of time. Both types of boundary conditions, velocity and pressure, assume either prescribed volume fractions together with component densities as a function of time or zero volume fractions and density derivatives. The fully implicit formulation framework described herein facilitates efficient solution of selected governing fluid flow equations and descriptions.

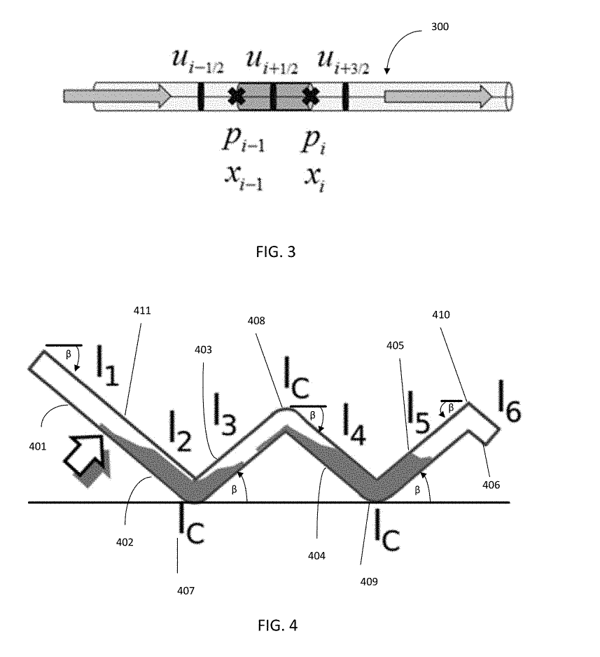

By way of non-limiting example, a finite volume approximation for the system of equations (1) to (9) was applied on an arbitrary, non-uniform, staggered grid 300 shown in FIG. 3 with an implicit backward Euler method and an upwind difference scheme for advective terms. See, e.g., Issa and Kempf, 2003, International Journal of Multiphase Flow, 29(1), pgs. 69-95.

The system of nonlinear algebraic equations R(wₙ₊₁)=0 obtained after discretization of the residuals R̅(w) (written in form of partial differential equations) must be solved at every time step, such as by using the Newton-Raphson method. Using a Taylor expansion, the function R at a point of wₙ₊₁, which is a solution vector at the next time step n+1, may be expressed as

R(wₙ₊₁)=R(w)+A(w)+δv+o(δv),wₙ₊₁w+δv (12)

where

$$A ( w ) = \frac{\partial R}{\partial w}$$

is the Jacobian matrix. As shown in Algorithm 1 below, taking into account R(wₙ₊₁)=0, and neglecting higher order terms o(δv), an iterative procedure may be used with the “l” number of Newton-Raphson iterations. Hence, a vector correction δv can be obtained from the expression (Algorithm 1, line 4):

A(w)δv=(w) (13)

Equation (13) represents a system of linear algebraic equations (SLAE) given after the discretization and linearization processes.

Algorithm 1
Algorithm 1 Newton-Raphson algorithm.

| 1: l = 0; | |
|---|---|
| 2: v^{l} = wⁿ; | |
| 3: while ∥ R (v^{l}) ∥ ≧ εᵣ do | |
| 4: | solve A(v^{l})δv^{l} = −R(v^{l}); |
| 5: | v^{l+1} = v^{l} + δv^{l}; |
| 6: | l = l + 1; |

7: end while
8: wⁿ⁺¹ = v^{l}.

Assuming that N is the number of cells in the staggered grid 300 of FIG. 3, the size of the discrete analogue for solution vector w containing primary variables would be of N(3N_{c}+1)+(N+1)N_{f} degrees of freedom. The condition ∥R(v^{l})∥<εᵣ with εᵣ=10⁻⁶ is used as a convergence criterion for the Newton iterations, and corresponding vector v^{l} is the desired discrete solution of the system of equations (1) of (9) at time step n+1. The convergence in terms of imbalances guarantees that the numerical solution approximates the governing equations within predetermined tolerances.

The solution strategy described above requires explicitly forming the Jacobian A for the set of governing and constitutive equations. Such a solution strategy may be a time-consuming exercise given a code which does not provide the derivatives evaluation. To facilitate solution activity, and to test the solution strategy above for multiphase flow problems, a Jacobian-Free Newton-Krylov (JFNK) iterative method may be used by way of non-limiting example to numerically form a matrix-vector multiplication product extensively used in iterative solvers. See, e.g., D. A. Knoll, D. E. Keyes, 2004, Journal of Computational Physics, 193(2), pgs. 357-397). The Jacobian-free approach can be used to show an example of a fully implicit solution method (by way of non-limiting example) with adaptive residuals formulation.

The Jacobian-free approach may be used without explicit definition of the Jacobian

$$A = \frac{\partial R}{\partial w} .$$

Instead of exact formulae for components of the Jacobian, one can numerically calculate matrix-vector product as:

$$\frac{\partial R}{\partial w} δ v \approx \frac{R ( w + ɛ δ v ) - R ( w )}{ɛ} . \qquad ( 14 )$$

To solve the SLAE (13) with the expression (14), methods may be used that only utilize matrix-vector operations. For this purpose, iterative methods may be used based on Krylov subspace (e.g., general minimal residual method (GMRES) described in Y. Saad, and M. Schultz, (1986), SIAM Journal on Scientific and Statistical Computing, 7, pgs. 856-869; and biconjugate gradient stabilized method (BiCGStab)). To avoid the basis vectors non-orthogonality due to computational round-off errors, an additional re-orthogonalization procedure can also be applied in some cases. See, e.g., L. Giraud, J. Langou and M. Rozloznik, 2005, Computers & Mathematics with Applications, 50, pgs. 1069-1075. Thus, in one embodiment, the overall procedure for solution of the governing equations (1) to (9) may be illustrated by Algorithm 2, below. It is important to note that Algorithm 2 (i.e., line 8) is based on Jacobian-Free Newton-Krylov (JFNK) approximation of matrix vector multiplication. Of course, it will be appreciated based on the foregoing discussion, that the general iterative linear solver (by way of non-limiting example flexible general minimal residual method (FGMRES)) with full Jacobian A may also be used.

Algorithm 2
Algorithm 2 Overall numerical time stepping procedure for solving governing system of equations (1)-
(8) with phase switching procedure.

| | |
|---|---|
| 1: | Set initial solution vector w⁰. |
| 2: | Set initial phase state distribution: |
| | $∀ γ , {( {s}_{γ} )}_{l}^{0} = \{ \begin{matrix}0 , if {( {α}_{γ} )}_{l}^{0} = 0 , \\ 1 , if {( {\tilde{α}}_{γ} )}_{l}^{0} > 0.\end{matrix}$ |
| 3: | for n = 0, . . . do |
| 4: | Partial reset of the phase states: |
| | $∀ γ , {( {s}_{γ} )}_{l}^{n + 1} = \{ \begin{matrix}1 , if {( {s}_{γ} )}_{l}^{0} = 1 , ( phase present at {t}^{n} ) \\ max ( {( {s}_{γ} )}_{i - 1}^{n} , {( {s}_{γ} )}_{i + 1}^{n} ) , if {( {s}_{γ} )}_{i}^{n} = 0 ( phase absent at {t}^{n} ) .\end{matrix}$ |
| 5: | Set v⁰ = wⁿ; l = 0. |
| 6: | Formulate residual vector R(v^{l}) according to (s_{γ})ₗⁿ⁺¹. |
| 7: | while \|\|R(v^{l})\|\| ≧ εᵣ do |
| 8: | Solve SLAE system (15): A(v^{l})δv^{l} = −R(v^{l}) using JFNK method. |
| 9: | if SLAE system is solved successfully then |
| 10: | Define Curry step length ω: min_{ωεR} \|\|R(v^{l} + ωδv^{l})\|\|, ω ε (0, 2]. |
| 11: | Update solution vector v^{l+1} = v^{l} + ωδwⁱ. |
| 12: | $Update phase state distributions \text{:} ∀ γ , {( {s}_{γ} )}_{l}^{n + 1} = \{ \begin{matrix}0 , if {( {\tilde{α}}_{γ} )}_{l}^{n + 1} < {ɛ}_{p} , \\ 1 , if {( {α}_{γ} )}_{l}^{n + 1} \geq {ɛ}_{p} .\end{matrix}$ |
| 13: | Formulate residual vector R(v^{l+1}) according to (s_{γ})ₑₗₛₑⁿ⁺¹. |
| 14: | else |
| 15: | Reduce time step Δtⁿ: go to 5. |
| 16: | end if |
| 17: | Move to the next Newton-Raphson iteration: l = l + 1, |
| 18: | end while |
| 19: | if ∃i, γ: ((s_{γ})ₗⁿ⁺¹ < (s_{γ})ₗⁿ) & ((α_{γ})ₗⁿ ≧ αⁿ) then |
| 20: | Reduce time step Δtⁿ: go to 5. |
| 21: | end if |
| 22: | wⁿ⁺¹ = v^{l}. |
| 23: | Move to the next time step: n = n + 1. |
| 24: | end for |

The direct solution of the governing system of equations (1) to (9) does not provide the regular transition from segregated flow to slug-type flow with phase degeneration in a pipe segment, and special techniques to simulate such a transition from single to two-phases or vice versa are provided. This refers to line 13 of the Algorithm 2, above.

The numerical modelling of phase appearance and disappearance presents a complex numerical challenge for all multi-component/multi-fluid models. A robust solution to the phase appearance and disappearance issue is provided hereinbelow. Without loss of generality, the following description is focused on the case of liquid slugs only. However, it will be appreciated that the same description is applicable more generally to the situation of both gas and liquid slugs.

Each cell of the pipeline may be considered to have a cell phase state. To model the cell phase state, an additional flag s_{γ}∀_{γ} for each cell is introduced. That additional flag indicates a presence of the phase (fluid), i.e. the gas phase state in case of a liquid slug is equal to 0, otherwise it is equal to 1. The phase state may be defined by the volume fractions distribution. The gas phase state flag may be changed from two-phase to single phase if \tilde{α}_{g} in Newton iterations becomes lower than a limiting value εₚ (typically, εₚ=10⁻³). The two exceptions for the phase state switching are related to boundary conditions and mass inflows: if a liquid cell has positive mass inflows of a gas phase, i.e., (J_{α})²+(J_{\tilde{w}})²≠0 (see equations (1) and (2)) or an entrance of the gas mass from the inlet boundary condition, the cell remains a two-phase cell regardless of the actual volume fractions distribution. The value of the volume fractions forming a disappeared phase are set to zero. In order to conserve the overall mass, the mass of the components forming a disappeared phase must be redistributed in the existing phases. According to the arrows shown in the tree diagram in FIG. 2, the mass of continuous components Aρₐⁿαₐⁿ/Δtⁿ and dispersed components Aρ_{\tilde{w}}ⁿα_{\tilde{w}}ⁿ/Δtⁿ are redistributed in the dispersed and continuous components (i.e., bubbles in the liquid and continuous water) respectively of the existing phases via the mass exchange mechanism (i.e., fluxes).

Algorithm 3
Algorithm 3 Residuals construction using the cell phase state flag.

| | |
|---|---|
| 1: | Given phase states ∀γ, (s_{γ})ₗⁿ⁺¹ |
| 2: | if ∃i,γ:(s_{γ})ₗⁿ⁺¹ = 0 then |
| 3: | ∀k ε I_{γ}, (αₖ)ₗⁿ⁺¹ = 0. |
| 4: | Define mapping Q: I_{γ} → E = {I_{ω}/(s_{ω})ₗⁿ⁺¹ ≠ 0} according to the tree-like graph. |
| 5: | Using an downwind scheme for i − 1 and i cells to preserve zero mass flux across a slug boundary. |
| 6: | Add to the list of residuals: Rₗ^{k,max} = 0, ∀k ∉ I_{γ}∪E. |
| 7: | Add to the list of residuals: Rₗ^{k,max} = (αᵢ)ₗⁿ⁺¹ = 0, |
| 8: | Add to the list of residuals: Rₗ^{k,max} + (Jᵢ*)ₗ 0, ∀I ε Q(I_{γ}) |
| 9: | $Add to the list of residuals \text{:} {R}_{i}^{ω , max} + {Ψ}_{ω}^{*} = 0 , ∀ ω \text{:} {I}_{ω} ∈ E ; {Ψ}_{ω}^{*} = {\sum }_{i ∈ {I}_{ω} ∈ E} {( {J}_{i}^{*} )}_{i} {( {\tilde{u}}_{γ} )}_{i}^{n} .$ |
| 10: | else |
| 11: | Add to the list of residuals: Rₗ^{k,max} = 0, ∀k ε I_{γ} and Rₗ^{γ,max} = 0. |
| 12: | end of |

The corresponding mass inflows (fluxes) are defined as: J*_{\tilde{α}}=−Aρₐⁿαₐⁿ/Δtⁿ and J*_{w}=−Aρ_{\tilde{w}}ⁿα_{\tilde{w}}ⁿ/Δtⁿ, that are all the masses are transferred from the continuous and dispersed to the dispersed and continuous components respectively of the same cell during a single time step Δtⁿ. The zero mass fluxes for the components forming disappeared gas phase on the faces of the slug must be preserved. The momentum equation of the gas phase, which is the source of the model inconsistency in slug regions, is ignored on all the faces of the slug cells. While the velocity of the absent phase could not be defined at all, for simplicity of code organization, the velocity was determined to be equal to the smallest velocity of the existing phase (e.g., liquid phase). The provided procedure describes the process of switching off the phases and corresponding changes for equations solved.

In addition, the procedure for phase appearance must be specified. It is assumed that the phase may only appear in the cell at the beginning of the next time step. Before the next time step calculations, the phase states are partially reset: every single-phase cell having a two-phase neighboring cell is marked as a two-phase cell. When switching on the continuous gas phase in the cell, the dispersed component is transferred back to the continuous component of the occurring phase as per the tree diagram of FIG. 2. As in a case of switching off, the corresponding mass flux of the continuous component is defined as J*ₐ=(Aρ_{ã}ⁿα_{ã}ⁿ)/Δtⁿ, and the mass exchange occurs during the one-time step. While the described procedure limits the transformation of the slug zones by one cell per time step per each slug face only, this restriction is not crucial, at least for modelling of terrain-induced, long-range slug flows.

A supplementary filtering technique may be used to choose the time integration step. In addition to Newton iteration convergence criteria, a limitation may be set on the volume fractions at which cells are switched off: the switching off is permitted for the cells with volume fractions being lower than some predefined value α* (typically, α*=10⁻² is used). If switching off for the cell with higher volume fractions has occurred, the obtained solution is ignored and recalculated again using the smaller time step Δtⁿ. The entire algorithm summarizing all the above is outlined in Algorithm 3.

An example application of using the above-disclosed methods to model terrain-induced slugging is presented below with reference to FIG. 4. The terrain-induced slugging processes have been demonstrated in various studies, where the system includes a W-shaped pipeline and a tank (not shown). The tank adds volume to the system. The connection between the tank and the pipeline allows only gas phase to enter the tank. The outlet has a sink to the atmosphere. Under constant inflows of air and water, the system may produce regular periodic slugs. For several inflows in the slugs have periods up to 200 s. See, e.g., De Henau and Raithby, 1995, Int. J. Multiphase Flow, 21(3), P. 365-379.

To reproduce the experiment of De Henau and Raithby, the pipeline configuration of FIG. 4 is as follows. A first segment 401 of pipe has a length of 53 m (60 cells) that mimics the tank volume used in the experiment of De Henau and Raithby, where the first 50 m and remaining 3 m were discretized using 50 and 10 cells respectively. The next four pipe segments (segments 402 to 405) have a length of 3.84 m (120 cells). The last pipe segment, segment 406, is 0.698 m (30 cells) long. Segment 406 is an additional segment that sustains the direction of the water outflow and simplifies the boundary conditions. All pipe segments have a diameter 0.052 m. Table 2 shows additional details of the configuration of the pipeline.

Also, the pipeline includes curved connections 407 to 410 between pipe segments 402 to 406. Along those connections 407 to 410, the inclination angle changes smoothly over a length of l_{c}=0.314 m (30 cells). An inflow zone 411 is located between the first pipe segment 401 and the second pipe segment 402 (as marked with an arrow). In the example shown in FIG. 4, the constant inflows are 0.1244 m³/s of air and 0.1287 m³/s of water. Initially, all of the pipe segments and connections are filled with air under atmospheric pressure. The properties of the fluids (parameters of PVT tables for phases at reference pressure P^{std}=10⁵ Pa) are specified in Table 1, below. The parameters used correspond to the ones of “Run 9” in De Henau and Raithby, 1995, Int. J. Multiphase Flow, 21(3), P. 365-379.

TABLE 1

| Fluid | Air | Water |
|---|---|---|
| Viscosity, μ × 10³, Pa · s | 0.017 | 1 |
| Reference density, ρ^{std}, kg/m³ | 1.22 | 1000 |
| Compressibility, C^{ρ}, Pa⁻¹ | | 10⁻⁹ |
| Density, ρ, kg/m³ | $\frac{{ρ}^{std} p}{{p}^{std}}$ | ρ^{std}(1 + C^{ρ}(ρ − P^{std})) |

For a simulation using the configuration of FIG. 4, the non-uniform grid of 660 cells (with refinement around the connections) is used, see Table 2. Phase switch refers to the threshold of εₚ=10⁻³. The simulation considers 500 s of the flow evolution recorded in the experiment.

TABLE 2

| Segment | l₁ | l₂ | l_{c} | l₃ | l_{c} | l₄ | l_{c} | l₅ | l₆ |
|---|---|---|---|---|---|---|---|---|---|
| Length, m | 53.0 | 3.84 | 0.314 | 3.84 | 0.314 | 3.84 | 3.84 | 0.314 | 0.698 |
| Inclination angle, ° | −25.7 | −25.7 | | 25.7 | | −25.4 | | 24.1 | −24.1 |
| Number of cells | 60 | 120 | 30 | 120 | 30 | 120 | 30 | 120 | 30 |

FIG. 5 is a graph of the liquid flow rate at the outlet of pipe segment 6 of FIG. 4 versus time and shown data from the numerical simulation, the experimental data from De Henau and Raithby, and data obtained using OLGA. As shown in FIG. 5, the multi-fluid model described herein reproduces the dynamic of slug formation (as compared to the experimental data) and the modeled outflow rate is close to the experimental one.

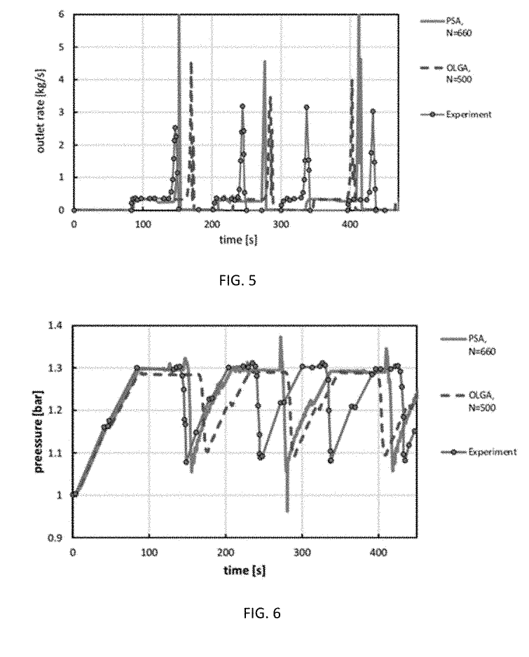

In experiments of De Henau and Raithby (1995), the pressure was measured in the first elbow. See, De Henau and Raithby, 1995, Int. J. Multiphase Flow, 21(3), pgs. 365-379. FIG. 6 is a graph of the pressure at the first elbow between segments 2 and 3 of FIG. 4 versus time and shows data from the fluid model described herein, the experimental data from De Henau and Raithby, and data obtained using OLGA. The graph shows pressure increasing, steadying, and decreasing periodically: as liquid accumulates in the elbows shown in FIG. 4, pressure builds up; pressure is steady when gas pushes liquid slugs out of the elbow; and a gas blow-out causes an abrupt pressure drop.

As noted above, FIGS. 5 and 6 also show simulated data output by OLGA. These results were simulated with a uniform grid of 500 cells, 80 cells forming a uniform grid in the first pipe segment, the rest of the cells forming a uniform grid over the other pipe segments. The difference in agreement between multi-fluid models and the experimental data of De Henau and Raithby is evident in FIGS. 5 and 6. The proposed model described herein is based on published calibrated friction factors. It is expected that the output of the proposed model can be improved by tuning the friction factors.

Table 3, below, shows a comparison of JFNK-GMRES and preconditioned (with block Jacobi preconditioning) BJAC-JFNK-GMRES for fluid flow in the W-shaped pipe of FIG. 4. Both examples use a non-uniform grid with N=660 cells; results for time step number 863, where the time interval t=10 s. As shown in Table 3, the preconditioning significantly improves the number of linears and corresponding computer processing time.

TABLE 3

| | JFNK-GMRES | BJAC-JFNK-GMRES |
|---|---|---|
| Non-linears | 5 | 4 |
| Linears | 7565 | 2815 |
| CPU time, s. | 85.0 | 16.1 |

A numerical process for identifying the slug formation proposed above can be used to cover flows of mixtures with an arbitrary number of phases and components. Indeed, the complexity of pipe flows may require the consideration of a variety of mixtures: water-oil-gas, water-bubbles-gas-droplets etc. The example of application for terrain-induced slugging in a two-phase flow pipeline demonstrates modelling capabilities that allow for the modeling of all the major features of the experimental data, and is in good quantitative agreement.

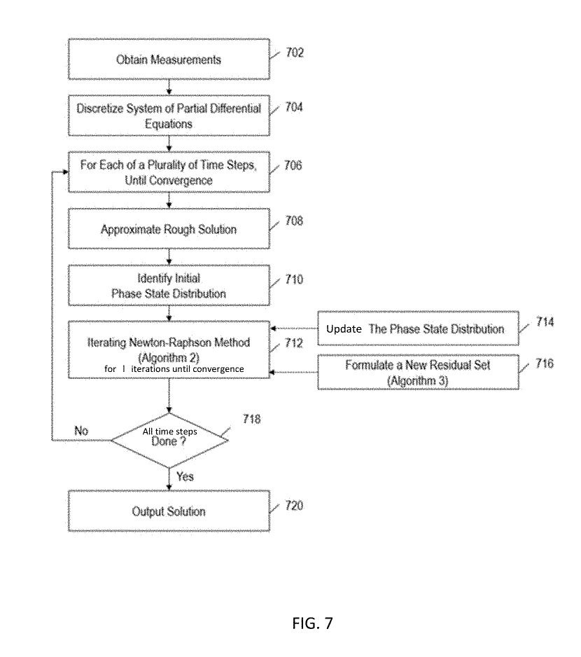

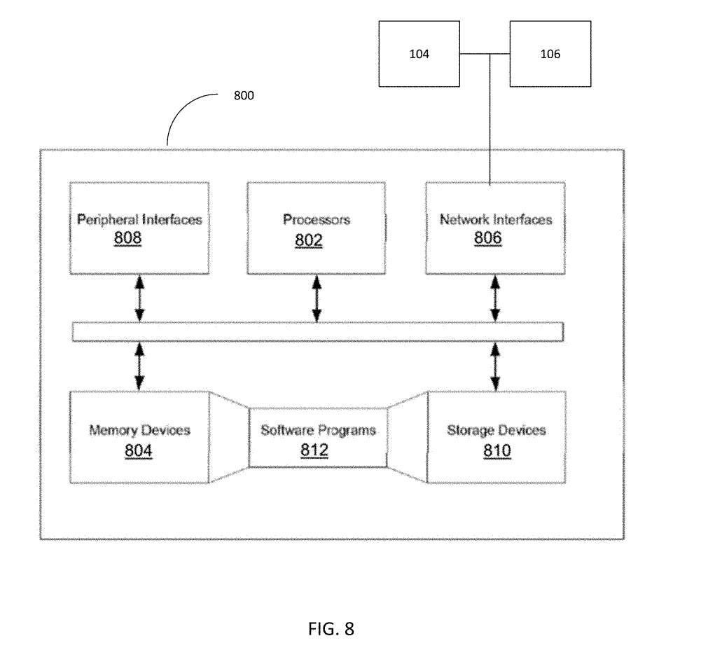

FIG. 7 is a flowchart depicting a method of identifying slug formation according to some embodiments. The method may be implemented using hardware, such as system 800 described in greater detail below with reference to FIG. 8. At block 702 measurements are obtained of one or more physical parameters (such as pressure) at a plurality of locations within the pipeline, e.g., pipeline of FIG. 4. Various techniques may be utilized to obtain such measurements, such as the use of down-hole sensors, such as pressure sensors 104 and 106 of FIG. 1 for measuring the pressure at the inlet and exit of each segment of the pipeline. As discussed above, it will be appreciated that when the pipeline is divided into a number of segments where each segment includes a grid of cells from the inlet to the outlet of the segment. The properties of the fluids at the boundary of adjacent cells will be the same to be logically consistent. Thus, the pressure at the inlet of a given pipe section may serve as the pressure of a cell located at the outlet of the pipe section upstream of the given pipe section, while the pressure at the outlet of the given pipe section may serve as the pressure to a cell located at the inlet of a pipe section downstream of the given pipe section,

At block 704, a system of partial differential equations is generated according to the measurements obtained at block 702 and are discretized into discrete difference equations suitable for numerical computing. For example, pressure measurement signals from the sensors 104 and 106 may be received by the system 800, which can form a system of partial differential equations according to those measurements. The discretization technique applied to such a system of equations may include, by way of non-limiting example, a finite-volume, second-order state, first-order time technique.

At block 706, one or more nested loops may be established for solving, at each of a plurality of time steps, for each of the plurality of physical parameter values. The outer loop may iterate once per time step, while an inner loop may perform multiple iterations of a numerical solution method (e.g., Newton-Raphson technique) at block 712, for example.

At block 708, a rough solution of the plurality of parameters is approximated. The technique to approximate the rough solution may utilize a numerical preconditioning process. At block 710, an initial cell phase state distribution is identified and set. At block 712, Newton-Raphson iterations are performed as per Algorithm 2, line 8. During the Newton-Raphson iterations the phase state distribution may be updated and a partial phase state reset (block 714) may be performed. Also, during the Newton-Raphson iterations a new residual set may be formulated (block 716) as per Algorithm 3. Newton-Raphson iterations are iteratively repeated at block 712 until convergence is reached. At block 718, it is determined whether a solution to the equations has been found for each time step. If it is determined that a solution to the equations has not been found for each of the times steps (i.e., No at block 718), then the outer loop iteration is repeated again for the next time step. However, if it is determined that a solution to the equations has been found for each of the times steps (i.e., Yes at block 718), then a solution to the system of partial differential equations is output at block 720. Outputting a solution may take on various forms. For example, the outputting may include displaying a pictorial representation of all or part of the pipeline, displaying one or more graphs depicting one or more physical parameters, delivering data to a separate process, or other outputting techniques.

FIG. 8 illustrates a schematic view of a computing or processor system 800, according to an embodiment. The processor system 800 may include one or more processors 802 of varying core configurations (including multiple cores) and clock frequencies. The one or more processors 802 may be operable to execute instructions, apply logic, etc. It will be appreciated that these functions may be provided by multiple processors or multiple cores on a single chip operating in parallel and/or communicably linked together. In at least one embodiment, the one or more processors 802 may be or include one or more CPUs/GPUs.

The processor system 800 may also include a memory system, which may be or include one or more memory devices and/or computer-readable media 804 of varying physical dimensions, accessibility, storage capacities, etc. such as flash drives, hard drives, disks, random access memory, etc., for storing data, such as images, files, and program instructions for execution by the processor 802. In an embodiment, the computer-readable media 804 may store instructions that, when executed by the processor 802, are configured to cause the processor system 800 to perform operations. For example, execution of such instructions may cause the processor system 800 to implement one or more portions and/or embodiments of the methods described herein.

The processor system 800 may also include one or more network interfaces 806. The network interfaces 806 may include any hardware, applications, and/or other software. Accordingly, the network interfaces 806 may include Ethernet adapters, wireless transceivers, PCI interfaces, and/or serial network components, for communicating over wired or wireless media using protocols, such as Ethernet, wireless Ethernet, etc. The network interfaces 806 may be communicatively coupled to the pressure sensors 104 and 106 of FIG. 1.

The processor system 800 may further include one or more peripheral interfaces 808, for communication with a display screen, projector, keyboards, mice, touchpads, sensors, other types of input and/or output peripherals, and/or the like. In some implementations, the components of processor system 800 need not be enclosed within a single enclosure or even located in close proximity to one another, but in other implementations, the components and/or others may be provided in a single enclosure.

The memory device 804 may be physically or logically arranged or configured to store data on one or more storage devices 810. The storage device 810 may include one or more file systems or databases in any suitable format. The storage device 810 may also include one or more software programs 812, which may contain interpretable or executable instructions for performing one or more of the disclosed processes. When requested by the processor 802, one or more of the software programs 812, or a portion thereof, may be loaded from the storage devices 810 to the memory devices 804 for execution by the processor 802.

Those skilled in the art will appreciate that the above-described componentry is merely one example of a hardware configuration, as the processor system 800 may include any type of hardware components, including any necessary accompanying firmware or software, for performing the disclosed implementations. The processor system 800 may also be implemented in part or in whole by electronic circuit components or processors, such as application-specific integrated circuits (ASICs) or field-programmable gate arrays (FPGAs).

The steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

There have been described and illustrated herein several embodiments of a method and system for identifying slug flow. While particular embodiments have been described, it is not intended that the invention be limited thereto, as it is intended that the invention be as broad in scope as the art will allow and that the specification be read likewise. Thus, while particular numerical techniques have been disclosed, it will be appreciated that other numerical techniques may be used as well. In addition, while particular types of hardware have been disclosed for a system, it will be understood other hardware can be used. It will therefore be appreciated by those skilled in the art that yet other modifications could be made to the provided invention without deviating from its spirit and scope as claimed.

What is claimed is:

1. A method of investigating slug flow in a pipeline, comprising:
defining a plurality of one-dimensional cells along a length of the pipeline, wherein the cells correspond to at least one portion of the pipeline;
obtaining a plurality of measurements of at least one physical parameter at a plurality of positions along the length of the pipeline;
generating a model of multiphase flow in the plurality of cells over time based at least on the plurality of measurements;
solving the model for a time period of interest to identify at least one property of multiphase flow in the plurality of cells for the time period of interest; and
evaluating the at least one property of multiphase flow in the plurality of cells for the time period of interest to predict occurrence of slug flow in the pipeline for the time period of interest.

2. The method of claim 1, wherein:
the pipeline is partitioned into sections; and
the plurality of measurements of the at least one physical parameter is obtained at the inlet and outlet of each section of the pipeline.

3. The method of claim 2, wherein:
at least one section extends at a positive or negative angle of inclination with respect to horizontal; and
the model accounts for the positive or negative angle of inclination of the at least one section.

4. The method of claim 1, wherein:
the at least one physical parameter comprises pressure.

5. The method of claim 1, wherein:
at one property of multiphase flow includes a phase state distribution for each cell.

6. The method of claim 6, wherein:
the phase state distribution for a given cell indicates whether the cell has a single phase or has multiple phases.

7. The method of claim 5, wherein:
the phase state distribution for a given cell represents volume fraction distributions for different phases contained in the cell.

8. The method according to claim 1, wherein:
generating the model includes discretizing a system of partial differential equations that model multiphase flow in each cell over time.

9. The method according to claim 8, wherein:
solving the model includes solving the system of partial differential equations to determine at least one property of multiphase flow in each cell over a period of time.

10. The method according to claim 9, wherein:
the system of partial differential equations is solved by approximating a rough solution to the system of partial differential equations.

11. The method according to claim 9, wherein:
the system of partial differential equations is solved based on an identified phase state distribution among the cells based on volume fraction distributions for different phases contained in the cells.

12. The method according to claim 1, wherein:
the model of multiphase flow includes a model for single-phase cells that is different from a model for multiphase cells, and the proper model is selected (or switched) as the phase characteristics of the multiphase flow of the cells change over time.

13. The method of claim 1, wherein:
the multiphase flow includes a continuous liquid phase component and a gas phase component dispersed as slugs in the continuous liquid phase component

14. The method of claim 1, wherein:
the multiphase flow includes a continuous liquid phase component and a liquid phase component dispersed as slugs in the continuous liquid phase component.

15. A non-transitory computer-readable medium containing computer instructions stored therein for causing at least one computer processor to perform a method of investigating slug flow in a pipeline, the method comprising:
defining a plurality of one-dimensional cells along a length of the pipeline, wherein the cells correspond to at least one portion of the pipeline;
obtaining a plurality of measurements of at least one physical parameter at a plurality of positions along the length of the pipeline;
generating a model of multiphase flow in the plurality of cells over time based at least on the plurality of measurements;
solving the model for a time period of interest to identify at least one property of multiphase flow in the plurality of cells for the time period of interest; and
evaluating the at least one property of multiphase flow in the plurality of cells for the time period of interest to predict occurrence of slug flow in the pipeline for the time period of interest.

16. The method of claim 15, wherein:
the pipeline is partitioned into sections; and
the plurality of measurements of the at least one physical parameter is obtained at the inlet and outlet of each section of the pipeline.

17. The method of claim 16, wherein:
at least one section extends at a positive or negative angle of inclination with respect to horizontal; and
the model accounts for the positive or negative angle of inclination of the at least one section.

18. A system for investigating slug flow in a pipeline, comprising:
a plurality of sensors that measure at least one physical parameter at a plurality of positions along the length of the pipeline; and
a computer processing system, including at least one computer processor and a computer memory, wherein the computer processing system is configured to investigating slug flow in a pipeline by a number of operations that include:
i) defining a plurality of one-dimensional cells along a length of the pipeline, wherein the cells correspond to at least one portion of the pipeline,
ii) obtaining the plurality of measurements made by the plurality of sensors,
iii) generating a model of multiphase flow in the plurality of cells over time based at least on the plurality of measurements,
iv) solving the model for a time period of interest to identify at least one property of multiphase flow in the plurality of cells for the time period of interest, and
v) evaluating the at least one property of multiphase flow in the plurality of cells for the time period of interest to predict occurrence of slug flow in the pipeline for the time period of interest.

19. The system of claim 18, wherein:
the pipeline is partitioned into sections; and
the plurality of measurements of the at least one physical parameter is obtained at the inlet and outlet of each section of the pipeline.

20. The system of claim 19, wherein:
at least one section extends at a positive or negative angle of inclination with respect to horizontal; and
the model accounts for the positive or negative angle of inclination of the at least one section.
